(19) United States
(12) Patent Application Publication
(10) Pub. No.: US 2024/0052674 A1
(43) Pub. Date: Feb. 15, 2024

(54) BICYCLE LOCKING SYSTEM

(71) Applicant: Jeff Hempleman, Gilbert, AZ (US)

(72) Inventor: Jeff Hempleman, Gilbert, AZ (US)

(21) Appl. No.: 18/128,084

(22) Filed: Mar. 29, 2023

Related U.S. Application Data
(60) Provisional application No. 63/397,278, filed on Aug. 11, 2022.

(51) Int. Cl. E05B 47/00; B62H 3/12; B62H 5/14

(52) U.S. Cl. CPC E05B 47/0012; B62H 3/12; B62H 5/14; E05B 2047/0017; E05B 2047/002; E05B 2047/0036; E05B 2047/0084; E05B 2047/0058; E05B 2047/0094

(57) ABSTRACT

A bicycle mounting system for securing a bicycle to a surface comprising a body having an open end and a closed end wherein the closed end can have a first hole and a second hole. The bicycle mounting system can have a stationary bar and a moveable bar wherein the moveable bar that can be selectively moveable between an open position and a closed position through the first hole and the stationary bar can be coupled to the body through the second hole. A cover can be removably coupled to the open end wherein the cover can be secured to the surface.

### CROSS-REFERENCE TO RELATED APPLICATIONS

This application claims benefit from currently pending U.S. Provisional Application No. 63/397,278 titled “BICYCLE LOCKING SYSTEM” and having a filing date of Aug. 11, 2022, all of which is incorporated by reference herein.

### TECHNICAL FIELD

The present specification relates to a bicycle lock and more specifically to a roof mounted or wall mounted bicycle lock system that automatically opens and alerts the user when tampered with.

### BACKGROUND OF THE INVENTION

Typically, users store their bicycles in the garage safe away from thieves. However, some users forget to close their garage and their bicycles still get stolen. So, individuals have started to put bicycle locks on their bicycles in the garage to help deter thefts. There are a number of bicycle locks that are available to prevent theft, such as a lock, chain, or cable. Each of these systems requires that the lock be attached to another stationary item that are anchored to the ground such as a stationary pole or bicycle rack that cannot be easily carried away by the thief. However, once the lock or anchor is broken the bicycle can be ridden or carried away.

There are several problems associated with the standard bicycle lock or storage rack. One is that the lock has to be attached to an anchor, usually homeowners do not have an anchor specific for a bike lock and have to drill into their concrete slap or walls. Another is that if the bicycle owner stores the bicycle overhead or on a wall mount, the mounts only allow the bike to hang and do not lock and if they do lock, the locks are not robust enough to actually overcome the pulling force of the thief on the bicycle and the wall mount. Most, if not all, storage racks do not lock the bicycle onto the wall or ceiling. The current mounting solutions only allow the user to hang their bicycle on a hook, or clamp light device.

Another common device is a hoist or winch that lifts the bicycle from a chain or cable. To lift or lower the bicycle the user must manually or electrically through a motor lift the bicycle up on the ceiling. Usually, the bicycle is placed on hooks through its handlebars, tires, or seat and then hoisted to the ceiling. The hooks are attached to a rope and pulley system wherein when the rope is pulled the bicycle is lifted to the ceiling. This design does not allow the bicycle to be locked to the hooks allowing someone to easily remove it from the hooks and take it.

Therefore, there is a need for a bicycle lock that securely attaches to a ceiling or wall that allows the user to securely lock his/her bicycle.

### BRIEF SUMMARY OF THE INVENTION

In embodiments a bicycle mounting system for securing a bicycle to a surface that can comprise a body having an open end and a closed end wherein the closed end can have a first hole and a second hole. The bicycle mounting system can have a stationary bar and a moveable bar wherein the moveable bar that can be selectively moveable between an open position and a closed position through the first hole and the stationary bar can be coupled to the body through the second hole. A cover can be removably coupled to the open end wherein the cover can be secured to the surface. The moveable bar has female threads on one end that can be coupled to a screw wherein the movable bar can be selectively moveable by a motor, gear box and the screw wherein the screw can be an acme screw. The stationary bar can be coupled to the body by at least one fastener. A gasket can be coupled between the cover and the open end wherein the cover and the open end can be coupled together by at least one fastener.

The motor can be controlled by micro-controller unit that can be attached to a power source and a wireless module wherein the micro-controller, power source and wireless module can be coupled to the inside of the body. The stationary bar can be in the shape of a J and can have a first end and a second end wherein the first end can have a female thread, and the second end can have a first cap. The stationary bar can have a second cap that mates with the first cap when the moveable bar is in its closed position. The power source can be lithium batteries or can be plugged into an AC power source. The wireless module can be Bluetooth or Wi-Fi device that communicate remotely with a user's portable computing device. The body can further comprise a switch and LED power indicator.

The switch can be a push button, digital, analog or touch screen. The stationary bar and moveable bar are coated with or surround by a protective cover wherein the protective cover can be silicone, neoprene or rubber. The body can have a gasket and a cover attached to its upper portion wherein the cover, gasket and body can be attached to each other by at least on fastener. The controller can be a microcontroller that activates the motor in forward or revers depending on the user's input, and controls power requirements be each component. The cover can have at least one mounting fastener coupled to it wherein the mounting fastener is attached to the surface wherein the surface is a ceiling and/or wall. The motor can activate and lock the movable bar in its closed position. The motor can be a stepper motor, dc motor or ac motor.

In other embodiments, the bicycle locking system comprising a hook wherein the hook can be coupled a first arm by a first link wherein the first link can attach the hook to the first arm. The hook can partially have a spring around it wherein the spring can be encapsulated by a spring support. The hook can compress the spring when it is pulled down within the spring support wherein the spring can return the hook to its original position. The hook can be attached to the first link and first link can be attached to the first arm by at least one fastener. The first arm can extend from the hook wherein the locking arm can attach to or in contact with the first arm. The locking arm can have a first end and a second end. The first arm can have a linkage end and a lifting end wherein the lifting end can push against the locking arm.

The first arm can extend from the hook upper portion to a locking arm. The locking arm can have a second pivot joint wherein the second pivot joint can comprise a bearing or a pin wherein the locking arm can rotate freely about the second pivot joint. The locking arm can have a first end and a second end. The first arm can have a linkage end and a lifting end. The locking arm can rotate about the second pivot joint when the hook is pulled down.

The bicycle locking system can further comprise a lock. The lock can keep the locking arm from extending outward thus locking the bicycle's tire within the bicycle locking system. The bicycle locking system can have a mount that can be attached to a wall or ceiling by at least one fastener wherein the mount can be attached to at least one hook, first arm and locking arm.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the bicycle locking system in accordance to one, or more embodiments;

FIG. 2 is a front view of another embodiment of the bicycle locking system in accordance to one, or more embodiments;

FIG. 3 is a side view of another embodiment of the bicycle locking system in accordance to one, or more embodiments;

FIG. 4 is a back view of a bicycle locking system showing different locking orientations in accordance to one, or more embodiments;

FIG. 5a is a bottom view of a bicycle locking system showing different locking orientations in accordance to one, or more embodiments;

FIG. 5b is cross-sectional view of a bicycle locking system showing different locking orientations in accordance to one, or more embodiments;

FIG. 6 is an isometric view of the bicycle locking system in accordance to one, or more embodiments;

FIG. 7 is a font view of another embodiment of the bicycle locking system in accordance to one, or more embodiments;

FIG. 8 is an front view of another embodiment of the bicycle locking system in accordance to one, or more embodiments;

FIG. 9 is an front view of another embodiment of the bicycle locking system in accordance to one, or more embodiments;

FIG. 10 is an isometric view of another embodiment of the bicycle locking system in accordance to one, or more embodiments;

FIG. 11 is an isometric view of another embodiment in its open and closed position of the bicycle locking system in accordance to one, or more embodiments;

FIG. 12 is an isometric view of another embodiment of the bicycle locking system attached to a ceiling in accordance to one, or more embodiments;

FIG. 13 is an isometric view of another embodiment of the bicycle locking system attached to a ceiling in accordance to one, or more embodiments; and

FIG. 14 is an isometric view of another embodiment of the bicycle locking system attached to a ceiling in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

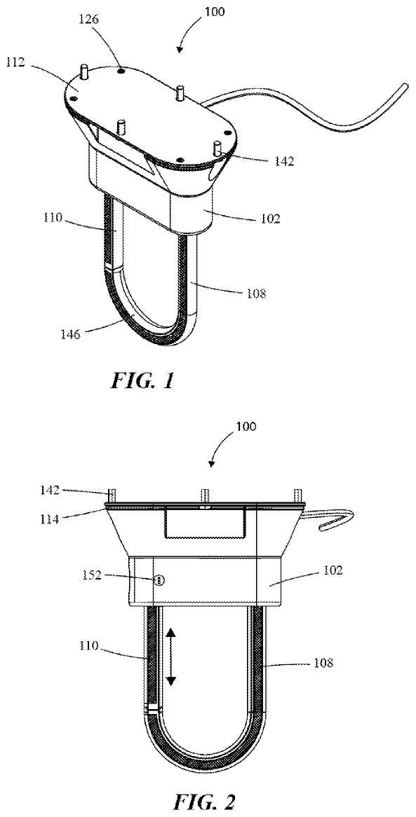

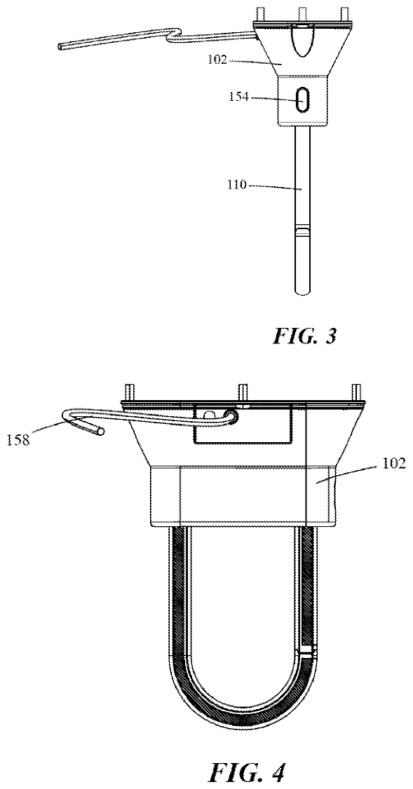

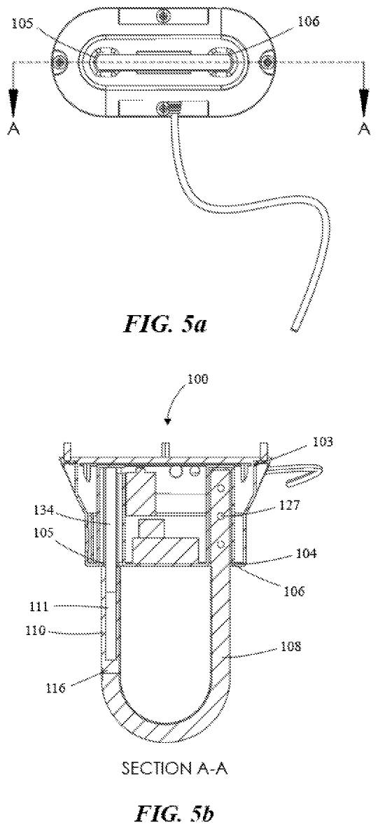

Referring initially to FIG. 1-5 a bicycle locking system is shown generally at 100. The bicycle mounting system 10 for securing a bicycle to a surface that can comprise a body 102 having an open end 103 and a closed end 104 wherein the closed end can have a first hole 105 and a second hole 106. The bicycle mounting system 100 can have a stationary bar 108 and a moveable bar 110 wherein the moveable bar can be selectively moveable between an open position and a closed position through the first hole 105 and the stationary bar can be coupled to the body 102 through the second hole 106. The stationary bar 108 can be in the shape of a J but in other embodiments it can be such as, for example, U-shape, V-shape, or any other suitable shape. The stationary bar 108 and movable bar 110 can be made from such as, for example, stainless steel, aluminum, carbon steel, carbon fiber, plastic or the like. The stationary bar 108 and the movable bar 110 can be such as, for example, circular, oval, flat with radius edges, octagonal, hexagonal or the like in shape. The stationary bar 108 can be surrounded by, partially surrounded, or coated with a wheel guard 146 which can be such as, for example, silicon, plastic cover, neoprene, thermoplastic dip, PTFE coating, or the like. In certain embodiments, the stationary bar 108 can be wide enough to hold multiple sizes of bike tires or multiple bikes.

The stationary bar 108 can have a stationary bar first end 123 and a stationary bar second end 124 wherein the stationary bar first end can have at least one third hole 127. The stationary bar 108 can be coupled to the body 102 by at least one third hole 127 and by at least one fastener 109 wherein the stationary bar 108 can be inserted into the body and the fasteners can be within the body so the user cannot have access to the fasteners. The stationary bar second end 118 can have a second cap 120 can be coupled to it wherein the second cap can be coupled by such as, for example, press fit, adhesive, fasteners, pin and joint or the like. The at least one fastener can be such as, for example, at least one fastener, welded, pins, rivets, or the like.

The moveable bar 110 can have a moveable bar first end 116 and a movable second end 118 wherein the movable second end 118 can have female threads 111 extending at a length down the middle of the moveable bar. The female threads can be rotatably coupled to a screw 134 wherein the screw can be such as, for example an acme screw, lead screw, linear screw, or the like. The movable bar 110 can be selectively moveable between an open position and a closed position by a motor 130, gear box 132 and the screw 134 as chosen by the user. The moveable bar 110 can move in and out of the first hole 105 partially showing the movable bar when in its open position and substantially showing the moveable bar in its closed position. The moveable bar second end 118 can have a first cap 113 coupled to it by such as, for example, press fit, adhesive, fasteners, pin and joint or the like. The second cap 120 can meet with a first cap 113 when in its closed position. In certain embodiments, the movable bar 110 can be surrounded by, partially surrounded, or coated with a wheel guard which can be such as, for example, silicon, plastic cover, thermoplastic dip, PTFE coating, or the like.

In embodiments, the motor 130 can be controlled by micro-controller unit (“MCU”) 128 that can be attached to a power source 136 and a wireless module 138 wherein the MCU, power source and wireless module can be coupled to the inner body 122 of the body 102. The motor 130 can activate and lock the movable bar 110 in its closed position. The motor 130 can be such as, for example, a stepper motor, DC motor, or AC motor. The wireless module 138 can be such as, for example, a Radio Frequency (RF), 802.11a, 802.11b, 802.11g, 802.11n, 802.15.4 (ZigBee), 802.16a, 802.16g, “Wireless Fidelity” (WiFi), “Worldwide Interoperability for Microwave Access” (WiMAX), European Telecommunications Standards Institute (ETSI) High Performance Radio Metropolitan Area Network (HIPERMAN), RF-Home, wireless personal area network (WPAN), Radio Frequency Identifier (RFID), Near Field communications (NFC) and/or machine-to-machine (M2M) communications or other types of wireless interfaces. However, the present invention is not limited to such wireless interface and other types of wireless communications can also be used.

The wireless module 138 can transmit and receive commands from the user's portable computing device or any other computing device wherein the commands can be such as, for example, status of device, status of moveable bar 110 whether it is open or closed, battery status, tamper detection, or the like. The MCU 128 can control the motor and communicate with the wireless module 138 that activates the motor in forward or revers depending on the user's input, and controls power requirements of each component. The moveable bar 110 and/or stationary bar 108 can have a load sensor and/or switch attached to it so that the MCU 128 can recognize when the bike is on the stationary bar so that once the bike is inserted it will lower the actuating bar to secure the bike. In certain embodiments the first cap 113 and the second cap 120 can be a carabiner style lock so that it is harder to separate the stationary bar 108 and moveable bar 126.

The power source 136 can be such as, for example, lithium batteries, alkaline batteries, carbon zinc batteries, silver oxide batteries, or the like. The power source 136 can be removable and replaced wherein the body 102 can have a power source cover 148 to allow the user access to the power source. In other embodiments the power source can be an AC power source plugged into the structure by a plug 158.

In embodiments, the body 102 can further comprise a fourth hole 150 wherein a switch 154 and/or a LED power indicator 156 can be coupled to. The switch 154 can have the LED incorporated within it and can allow the user to turn on and off the device. The switch 154 can be such as, for example, a push button, digital, analog or touch screen. In certain embodiments, the bicycle locking system 100 can have a key release 152 within its body 102 wherein the key release can allow the user to release the moveable bar 110 and move it from its closed to open position or open to closed position as shown in FIG. 2. The switch 154 can allow the user to turn on and off the device wherein a power indicator 114 can be on or next to the power switch which can show the status of the power source 136 through either a digital display or colors of a LED.

In embodiments, a cover 112 can be removably coupled to the open end 103 wherein the cover 112 can be secured to the body's open-end surface 107 by at least one second fastener 140 wherein the fastener can go through the cover and couple to the body. A gasket 114 can be coupled between the cover 112 and the open end 103. The cover 112 can have at least one mounting fastener 142 coupled to it wherein the mounting fastener can be attached to the surface wherein the surface can be such as, for example a ceiling, wall or the like and can have a flex mount to that the hook can be oriented in difference directions.

In other embodiments, there can be a remote mounted controller (not shown) so the user portable computing device can be bypassed, and the user can choose which device can unlocked activate the moveable bar 110 either by the remote mount or portable computing device. The portable computing device 10 can be on a timer wherein the moveable bar will lower after a certain of time locking the bike onto the device and the device can recognize when the bike is attached before lowering the moveable bar.

In certain embodiments the main body 102 can comprise a speaker, and at least one indicator wherein the indicator can be lights, a screen, or the like that can notify the user whether the bicycle locking system is locked or unlocked and the speaker can alarm the user if someone is tampering with the lock.

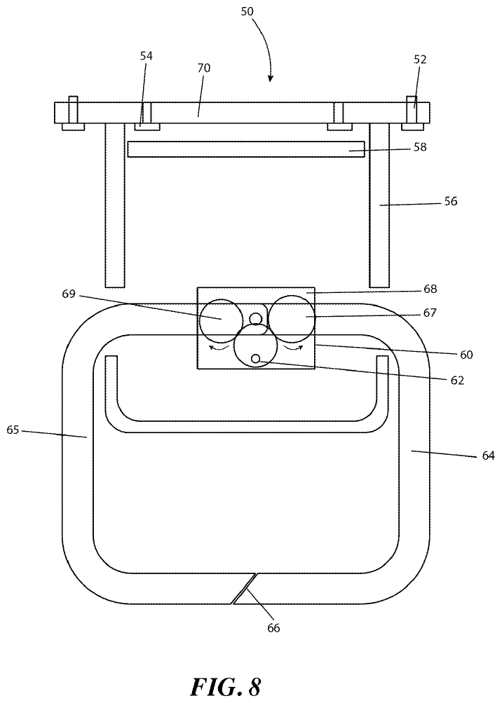

Now referring to FIG. 7 a bicycle locking system 10 comprising a hook 14 wherein the hook can have an upper portion 19 and a lower portion 21. The upper portion can be coupled a first arm 16 by a first link 17 wherein the first link can attach the hook 14 to the first arm 16. The hook 14 can be in the shape of such as, for example, U-shape, J-shape, or the like but can be any shape known the art and can have an array of ribs to strengthen the hook as shown in FIG. 8. The upper portion 19 can have a spring 20 around it wherein the spring can be encapsulated by a spring support 18.

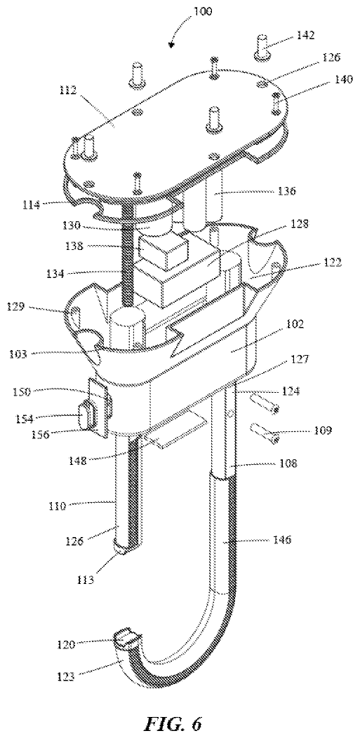

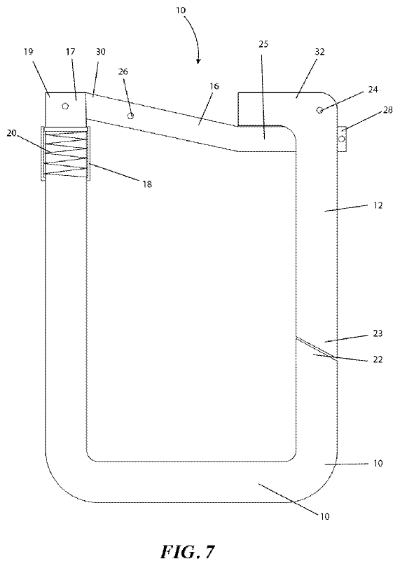

The upper portion 19 can compress the spring 20 when the hook 14 is pulled down within the spring support 18 wherein the spring can return the hook to its original position. The spring 20 can be such as, for example, compression spring, extension spring, wave spring, or the like. The upper portion 19 can be attached to the first link 17 and first link can be attached to the first arm 16 by at least one fastener. The first arm 16 can have first pivot joint wherein the first pivot joint can comprise a bearing or a pin wherein the first arm can rotate freely about the first pivot joint. In certain embodiments, the hook 14 can be lined with a material such as rubber, plastic, silicone or the like that can protect the bicycle's rim and tires as shown in FIG. 6.

The first arm 16 can extend from the hook 14 upper portion 19 to a locking arm 12 wherein the locking arm can attach to or in contact with the first arm. The locking arm 12 can have a second pivot joint 24 wherein the second pivot joint can comprise a bearing or a pin wherein the locking arm can rotate freely about the second pivot joint. The locking arm 12 can have a first end 32 and a second end 23. The first arm 16 can have a linkage end 30 and a lifting end 25 wherein the lifting end can push against the locking arm 12. The locking arm 12 can rotate about the second pivot joint 24 when the hook 14 is pulled down by the user pulling down on the first arm 16 reacting against the locking arm's 12 first end 32. The locking arm's 12 first end 32 can be a tab or a joint wherein the first arm is able to lift or release the first end pivoting the locking arm around the second pivot joint 24. The locking arm's 12 second end 23 can be a nose and the hook's 14 lower portion can be a gate 22 wherein nose can have a notch portion or can be a flat portion that meets up with the gate.

The bicycle locking system 10 can further comprise a lock wherein the lock 28 can be such as, for example, a solenoid, a pin, cam lock, electric lock, keyed lock, or the like. The lock 28 can keep the locking arm 12 from extending outward thus locking the bicycle's tire within the bicycle locking system. The bicycle locking system 10 can have a mount (not shown) that can be attached to a wall or ceiling by at least one fastener (not shown) wherein the mount can be attached to at least one hook 14, first arm 16 and locking arm 12. The mount (not shown) can be rotatable wherein the user can rotate the bicycle locking system 10 on its axis and lock it into place as shown in FIG. 13.

The indicator can be controlled by the MCU wherein the MCU can send a signal to the indicator of the status of the light displaying the state of the lock. The hook 14, locking arm 23 and the first arm 16 can be manufactured from such as, for example, carbon steel, stainless steel, aluminum, or the like. In other embodiments there can be a bypass key lock if there is power or electronic failure of the lock.

In embodiments, the wireless communication device can send and receive a signal to and from a portable computing device wherein the user can lock or unlock the bicycle locking system, detect if someone is or has tampered with the lock, status of the bicycle locking system, or the like. The portable computing device can be such as, for example, a smartphone, a tablet, a keypad, a computing system or the like. The at least one sensor can be such as for example, accelerometer, temperature, humidity, position sensor, hall effect sensor, or the like. The MCU can control the lock 28 and the electrical components sending and receiving a command from a user's portable computing device. The portable computing device can have an application installed on it that control the bicycle locking system 10. The application can accommodate multiple bicycle locking systems wherein the user can independently activate one bicycle locking system at a time.

In certain embodiments of use is such as, for example, the hook 14 can be pushed down in a vertical direction by a motor, actuator or the like wherein the when the hook is pushed down it reacts on the first arm 16 and the locking arm 12 lifting the locking arm long its pivot point, moving the locking arm away from the hook and allowing enough space between the hook and the locking arm to fit a bicycle's tire within the first body, first arm and locking arm. The motor or actuator (not shown) can be activated by the MCU wherein the MCU can receive a signal or command from a portable computing system,

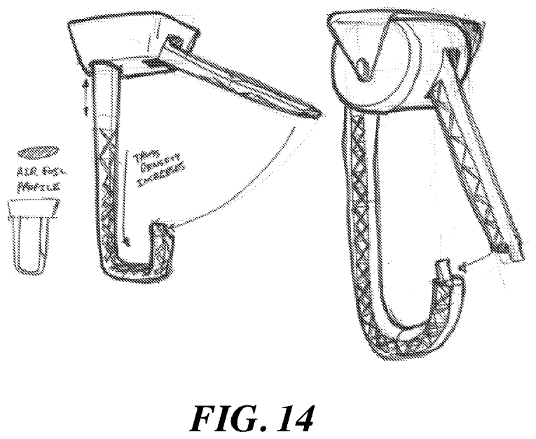

Referring to FIG. 8 another embodiment of a bicycle locking system 50 comprising a mount 70 having at least one hole wherein at least one fastener 52 can attach the mount to a ceiling. The mount 70 can be attached to a body 56 by one ore more fasteners. The body 56 wherein the body can be attached to the mount by at least one fastener 54 wherein the body can further comprise electronics 58 positioned inside the body and mounted to the upper portion or lower portion. The body 56 can have a motor 68 attached to it wherein the motor can have at least one gear couple to its motor rod (not shown). The bicycle locking system 50 can further comprise a first grip 64 and a second grip 65 wherein the first grip and the second grip can be in a such as, for example, U-shape, J-shape, or the like but can be any shape known the art and can have any type of structure such as an array of column to strengthen the structure the structure as shown in FIG. 14.

The motor 68 can be such as, for example, a DC motor, AC motor, brushless motor, stepper motor, or the like. The motor 68 can be attached directly to the first grip 64 and the second grip 65 or each grip can have its own motor, or each motor can have its own gear. In the preferred embodiment, the motor 68 can be attached to at least one main gear 62 wherein the gear can be attached to a first gear 67 and a second gear 69 wherein the first gear is attached to the first grip 64 and the second gear can be attached to the second grip 65 wherein the main gear can rotate the first gear and the second gear raising and lowering the first grip and the second grip. The gears can be such as, for example, spur gears, helical gears, rack and pinion, bevel gears miter gears or the like and can be planetary gear, two-way to a one-way rotation, or the like.

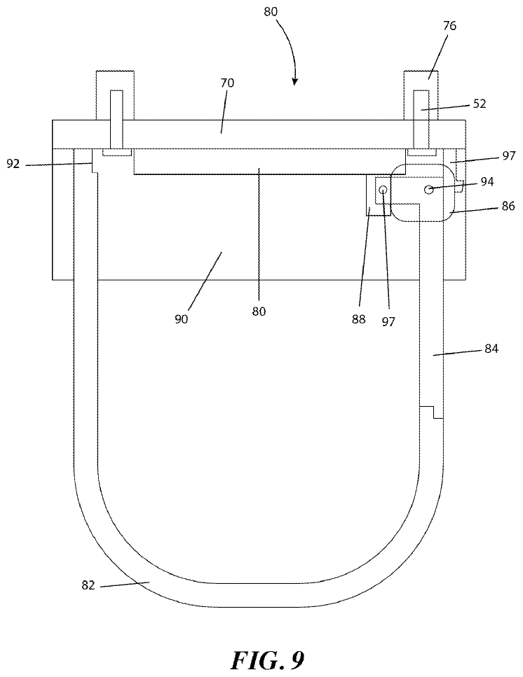

Referring to FIG. 9 another embodiment of a bicycle locking system 80 wherein the bicycle locking system can comprise a hook 82 and a locking arm 84 wherein the hook can be attached to a main body 90 and/or a mount support 80. The mount support can be attached to a ceiling 70 or wall by at least one fastener 52 and the hook 82 can be attached to the main body 90 and/or mount support 80 by such as, for example, at least one fastener, a weld, or the like. The at least one fastener can be attached to at least one ceiling stud 76. The mount support 80 and/or main body 90 can further comprise a motor 86 and a locking device 88. The motor 86 can be coupled to the locking arm 84 wherein when the motor is activated by a user it can raise and lower the locking arm about the motor's shaft axis 94, or in other embodiments the motor and locking arm can be couple by at least one gear.

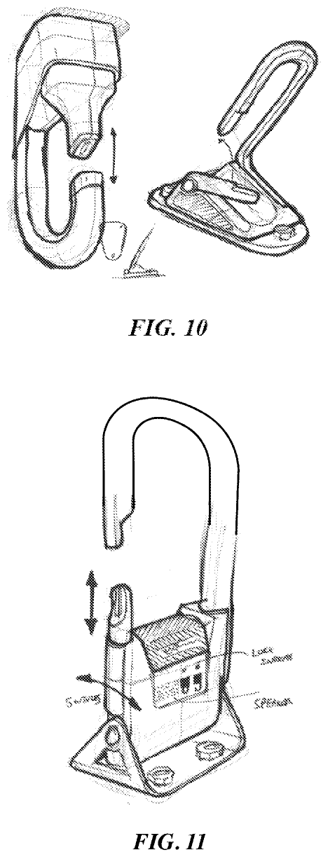

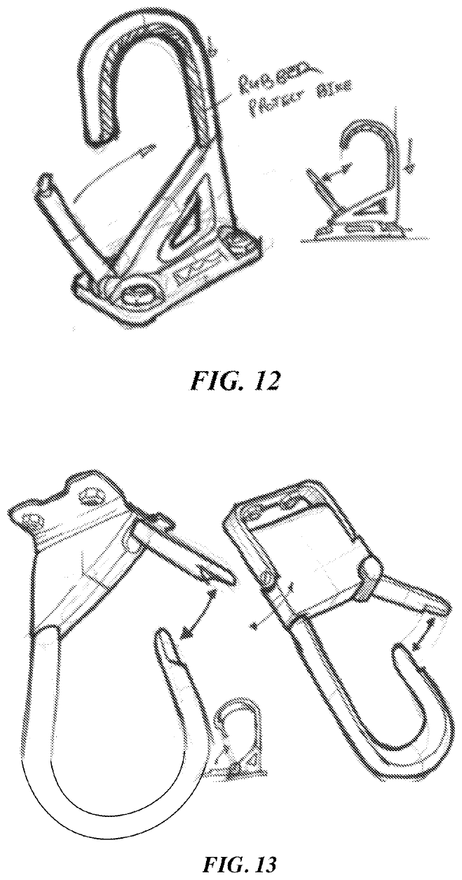

The locking arm 84 can further comprise at least one hole 97 wherein the locking device 88 can stop the locking arm from moving in and out and can unlock the locking arm by a signal from the user activating the locking device. The locking device 88 can be such as, for example, a solenoid, a pin, cam lock, electric lock, keyed lock, or the like. In certain embodiments, the locking arm 88 can fold down or move into the body 90 as shown in FIG. 10 through FIG. 13.

In embodiments a method of using a bicycle locking system can comprise using an application on a mobile computing device or a keypad to activate the locking device wherein the locking device can keep the locking arm from moving in an outward direction. Moving the locking arm away from the hook wherein the locking arm opens with enough distance to allow a bicycle's tire and wheel to be easily placed on the hook. Sending a signal to the MCU to close the locking arm wherein the locking device can be activated and keep the locking arm from extending outward.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A bicycle mounting system for securing a bicycle to a surface comprising:
a body having an open end and a closed end wherein the closed end has a first hole and a second hole;
a stationary bar and a moveable bar wherein the moveable bar is selectively moveable between an open position and a closed position through the first hole and the stationary bar is coupled to the body through the second hole; and
a cover removably coupled to the open end wherein the cover is secured to the surface.

2. The bicycle mounting system according to claim 1, wherein the moveable bar has female threads on one end that are coupled to a screw wherein the movable bar is selectively moveable by a motor, gear box and the screw wherein the screw is an acme screw.

3. The bicycle mounting system according to claim 1, wherein the stationary bar is coupled to the body by at least one fastener.

4. The bicycle mounting system according to claim 1, wherein a gasket is coupled between the cover and the open end wherein the cover and the open end are coupled together by at least one fastener.

5. The bicycle mounting system according to claim 1, wherein the motor is controlled by micro-controller unit (“MCU”) that is attached to a power source and a wireless module wherein the micro-controller, power source and wireless module are coupled to the inside of the body.

6. The bicycle mounting system according to claim 1, wherein the stationary bar is in the shape of a J and has a first end and a second end wherein the first end has a female thread, and the second end has first cap.

7. The bicycle mounting system according to claim 6, wherein the stationary bar has a second cap that mates with the first cap when the moveable bar is in its closed position.

8. The bicycle mounting system according to claim 5, wherein power source are lithium batteries or plugged into an AC power source.

9. The bicycle mounting system according to claim 5, wherein the wireless module is Bluetooth or Wi-Fi device that communicate remotely with a user's portable computing device.

10. The bicycle mounting system according to claim 1, wherein the body further comprises a switch and LED power indicator coupled to the body.

11. The bicycle mounting system according to claim 6, wherein the switch is a push button, digital, analog or touch screen.

12. The bicycle mounting system according to claim 1, wherein the stationary bar and moveable bar are coated with or surround by a protective cover wherein the protective cover is silicone, neoprene or rubber.

13. The bicycle mounting system according to claim 1, wherein body has a gasket and a cover attached to its upper portion wherein the cover, gasket and body can be attached to each other by at least on fastener.

14. The bicycle mounting system according to claim 1, wherein the controller is a microcontroller that activates the motor in forward or revers depending on the user's input, and controls power requirements be each component.

15. The bicycle mounting system according to claim 1, wherein cover has at least one mounting fastener coupled to it wherein the mounting fastener is attached to the surface wherein the surface is a ceiling and/or wall.

16. The bicycle mounting system according to claim 1, wherein the motor can activate and lock the movable bar in its closed position.

17. The bicycle mounting system according to claim 1, wherein the motor is stepper motor, dc motor or ac motor.

18. The bicycle mounting system according to claim 9, wherein the wireless module can communicate with a remote that the user can send a signal to open and close the moveable bar.

19. The bicycle mounting system according to claim 1, wherein the body has a keyhole to release the moveable bar.
